(19) United States
(12) Patent Application Publication
(10) Pub. No.: US 2020/0262294 A1
(43) Pub. Date: Aug. 20, 2020

(54) BACKUP INSTRUMENT CLUSTER DISPLAY FOR AN AUTOMOBILE

(71) Applicant: Ford Global Technologies, LLC, Dearborn, MI (US)

(72) Inventor: Roberto Gautier, Davie, FL (US)

(73) Assignee: Ford Global Technologies, LLC, Dearborn, MI (US)

(21) Appl. No.: 16/278,583

(22) Filed: Feb. 18, 2019

(51) Int. Cl. B60K 35/00

(52) U.S. Cl. CPC B60K 35/00; B60K 2350/1068; B60K 2350/96; B60K 2350/1076; B60K 2350/106

(57) ABSTRACT

Exemplary embodiments described in this disclosure are generally directed to systems and methods for configuring an infotainment display in an automobile to operate as a backup display to an electronic instrument cluster of the automobile in the event of a failure in the electronic instrument cluster. For example, if the electronic instrument cluster turns blank as a result of a failed component or a faulty power supply, at least some of the graphics that were displayed on the electronic instrument cluster are automatically displayed on the infotainment display. The graphics displayed on the infotainment display can include, for example, a speedometer graphic that is dynamically updated in a real-time mode of operation to indicate a speed at which the automobile is moving. The speedometer graphic on the infotainment display substantially replicates the speedometer graphic that was displayed on the electronic instrument cluster prior to the occurrence of the fault.

### FIELD OF THE DISCLOSURE

This disclosure generally relates to automobile displays, and more particularly relates to a backup arrangement for an instrument cluster display in an automobile.

### BACKGROUND

Automobile manufacturers constantly strive to incorporate into their automobiles, various features and gadgets that make their automobiles more attractive to buyers. One popular approach is aimed at replacing analog components and displays with digital components and displays. For example, components such as an analog speedometer and an analog tachometer, each of which includes a moving needle, are being replaced by an electronic display where the needle is a digital representation that simulates movement. Similarly, an analog radio that includes parts such as a volume control knob and a tuner knob is typically replaced with a digital radio having a touch screen display having icons that can be selected for executing radio functions such as volume and station tuning. Other components in an automobile such as a mechanical ignition switch and a mechanical distributor have been replaced with wireless key fobs and electronic controller cards that carry out equivalent functions electronically.

The transformation from analog technology to electronic technology in automotive practice provides numerous benefits. However, electronic components may fail abruptly and without warning due to various reasons such as electrical shorts, electrical surges, and power supply malfunctions. Some of these failures, such as a failed radio or an unreliable Bluetooth® telephone connection, are inconvenient but do not necessarily create risk. Failures in certain other electronic components that affect driving of the automobile can be more serious and lead to high risk. It is therefore desirable to address shortcomings and malfunctions associated with at least some electronic gadgets that are provided in an automobile.

### BRIEF DESCRIPTION OF THE DRAWINGS

A detailed description is set forth below with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 shows an electronic instrument cluster and an infotainment display that may be installed in an automobile.

FIG. 2 illustrates some details of the electronic instrument cluster shown in FIG. 1.

FIG. 3 illustrates some details of the infotainment display shown in FIG. 1.

FIG. 4 shows a system for configuring an infotainment display to operate as a backup display to an electronic instrument cluster in accordance with an exemplary embodiment of the disclosure.

FIG. 5 shows an infotainment display having a first exemplary display configuration when operating as a backup display upon an occurrence of a fault in the electronic instrument cluster.

FIG. 6 shows an infotainment display having a second exemplary display configuration when operating as a backup display upon an occurrence of a fault in the electronic instrument cluster.

FIG. 7 shows an infotainment display having a third exemplary display configuration when operating as a backup display upon an occurrence of a fault in the electronic instrument cluster.

FIG. 8 shows an infotainment display having a fourth exemplary display configuration when operating as a backup display upon an occurrence of a fault in the electronic instrument cluster.

FIG. 9 shows an infotainment display having a fifth exemplary display configuration when operating as a backup display upon an occurrence of a fault in the electronic instrument cluster.

FIG. 10 shows an exemplary system for configuring an infotainment display to operate as a backup display to an electronic instrument cluster in accordance with the disclosure.

### DETAILED DESCRIPTION

The disclosure will be described more fully hereinafter with reference to the accompanying drawings, in which exemplary embodiments of the disclosure are shown. This disclosure may, however, be embodied in many different forms and should not be construed as limited to the exemplary embodiments set forth herein. It will be apparent to persons skilled in the relevant art that various changes in form and detail can be made to various embodiments without departing from the spirit and scope of the present disclosure. Thus, the breadth and scope of the present disclosure should not be limited by any of the above-described exemplary embodiments but should be defined only in accordance with the following claims and their equivalents. The description below has been presented for the purposes of illustration and is not intended to be exhaustive or to be limited to the precise form disclosed. It should be understood that alternate implementations may be used in any combination desired to form additional hybrid implementations of the present disclosure. For example, any of the functionality described with respect to a particular component such as a first processor in a first computer may be performed by another component such as a second processor in another computer. Furthermore, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments.

Certain words and terms are used herein solely for convenience and such words and terms should be interpreted as referring to various objects and actions that are generally understood in various forms and equivalencies by persons of ordinary skill in the art. For example, the word “automobile” may be interchangeably used with the word “vehicle.” Words such as “graphics,” “icons,” “images,” “graphical representations,” and “replicas” may be interchangeably used herein when referring to displays such as the infotainment display or the electronic instrument cluster. The phrase “electronic instrument cluster” as used herein in the context of graphics and icons generally refers to a display component that is located upon a dashboard of a vehicle and is visible to the driver. However, it should be understood that the phrase can encompass not only the display component but also additional components such as a display driver board, a power supply board, or a display controller board that are coupled to the display component. Thus, a computer system that controls the electronic instrument cluster may include connections to the display component and/or the display controller board, for example. It should also be understood that the word “example” as used herein is intended to be non-exclusionary and non-limiting in nature. More particularly, the word “exemplary” as used herein indicates one among several examples, and it should be understood that no undue emphasis or preference is being directed to the particular example being described.

In terms of a general overview, certain embodiments described in this disclosure are directed to systems and methods for configuring an infotainment display in an automobile to operate as a backup display to an electronic instrument cluster of an automobile in the event of a failure in the electronic instrument cluster. For example, if the electronic instrument cluster turns blank as a result of a failed component or a faulty power supply, at least some of the graphics that were displayed on the electronic instrument cluster are automatically displayed on the infotainment display. The graphics displayed on the infotainment display can include, for example, a speedometer graphic that is dynamically updated in a real-time mode of operation to indicate a speed at which the automobile is moving. The speedometer graphic on the infotainment display substantially replicates the speedometer graphic that was displayed on the electronic instrument cluster prior to the occurrence of the fault.

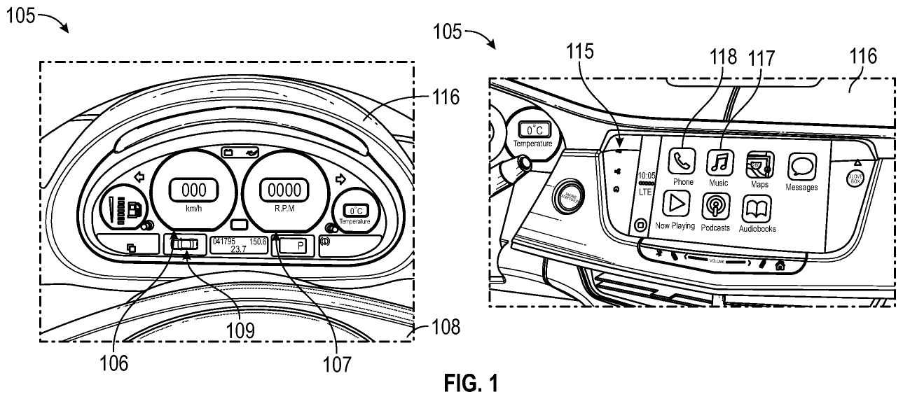

FIG. 1 shows an exemplary electronic instrument cluster 105 and an exemplary infotainment display 115 that may be installed in an automobile. The electronic instrument cluster 105 is typically located on a dashboard 116 of the automobile where a driver of the automobile can see various graphics that are displayed on the electronic instrument cluster 105. Depending on driver preference, a steering wheel 108 of the automobile may be placed in a raised position, and a portion of the electronic instrument cluster 105 may be visible through an opening in the steering wheel 108. In this example, the electronic instrument cluster 105 is an electronic display that graphically displays various gauges and icons associated with the operating parameters of the automobile. For example, the electronic instrument cluster 105 may include a speedometer 106 and a tachometer 107. The electronic instrument cluster 105 may also include icons and messages such as an icon 109 that indicates a location of an open car door.

The infotainment display 115 is typically located in a central area of the dashboard 116 of the automobile where the driver of the automobile or a passenger in the automobile can access various controls and icons displayed on the infotainment display 115. One of the icons can be a music icon 117, for example, that can be selected to play music in the automobile. Another icon can be a telephone icon 118 that can be selected to make a hands-free phone call in the automobile.

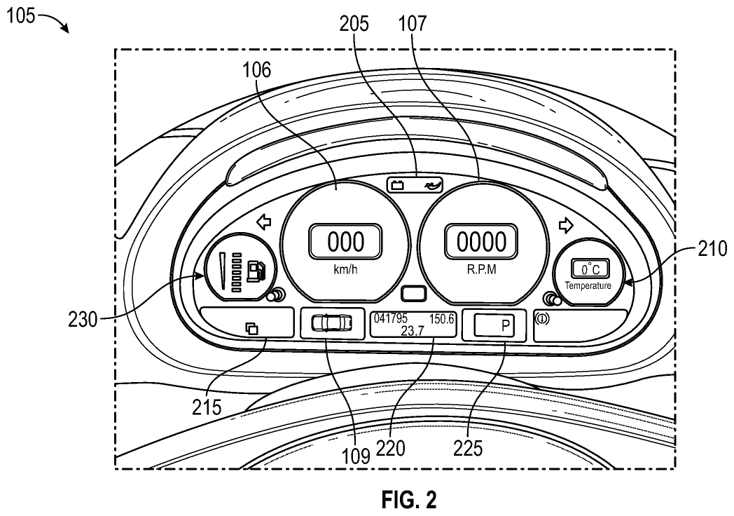

FIG. 2 illustrates some additional details of the exemplary electronic instrument cluster 105. The tachometer 107 is displayed in the electronic instrument cluster 105 in the form of an electronic representation of an analog gauge and includes a needle superimposed upon a dial having markings to indicate rotations per minute (rpm) of the engine in the automobile. The electronic representation of the tachometer 107 changes in real-time to reflect changes in rpm. The speedometer 106 is displayed in the exemplary electronic instrument cluster 105 in the form of an electronic representation of an analog gauge and includes a needle that is superimposed upon a dial having markings to indicate a speed of the automobile. The electronic representation of the speedometer 106 changes in real-time to reflect changes in the speed of the automobile. In an alternative embodiment, the speedometer 106 and the tachometer 107 may be displayed in a numerical format. For example, the speedometer 106 may indicate the numerals “55” when the automobile is traveling at 55 mph and the numerals “65” when the automobile is traveling at 65 mph.

The electronic instrument cluster 105 further includes electronic representations of other components such as a fuel gauge 230 and a temperature gauge 210, and graphics such as an odometer 220, a gear position indicator 225, a low-oil indicator 205, an engine status icon 215 (check-engine light), and an air-bag status icon. The various graphics displayed on the electronic instrument cluster 105 are dynamically updated by a controller (not shown) that monitors various operating parameters of the automobile (speed, engine rpm, etc.) and applies signals to the electronic instrument cluster 105 in order to update the graphics in a real-time mode of operation. The display screen of the electronic instrument cluster 105 may be a glass screen upon which the various images are projected. In some embodiments, the glass screen is a passive screen, and the driver is unable to modify the images by touching the display screen. However, in some other embodiments, the display screen of the electronic instrument cluster 105 may be a touch screen component that allows a driver to modify the displayed images by touching the touch screen.

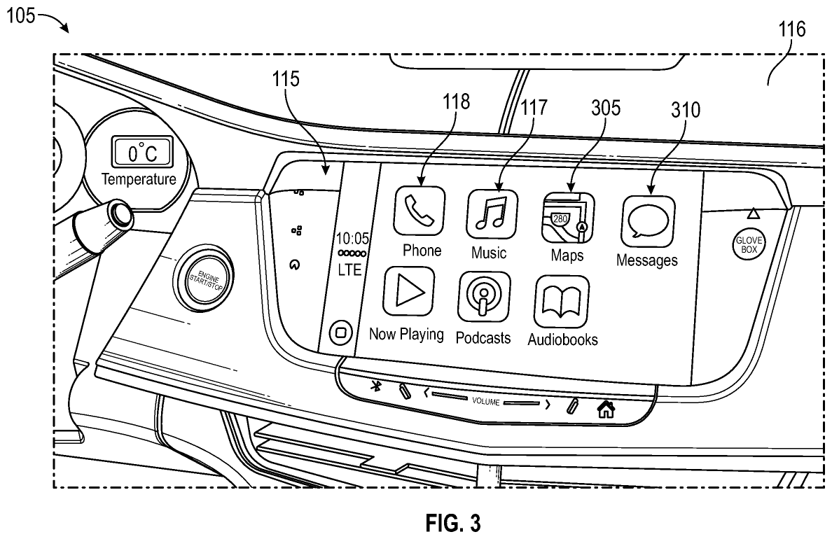

FIG. 3 illustrates some additional details of the exemplary infotainment display 115. In an exemplary embodiment, the infotainment display 115 has a touch screen that displays various icons such as the telephone icon 118, the music icon 117, a map icon 305, and a messages icon 310. An occupant of the automobile may touch any of the icons to activate various functions. For example, a driver may touch the map icon 305 to obtain navigation directions. When touched, some or all of the icons may transform a portion of the infotainment display 115 or the entire infotainment display 115 to display additional graphics and/or images. For example, when the map icon 305 is touched, the infotainment display 115 may change to display a navigation map, and when the telephone icon 118 is touched, the infotainment display 115 may change to display a list of telephone numbers. In some other embodiments, the infotainment display 115 may be controlled by using a voice interface. The voice interface may be used by the driver, for example, to display a navigation map upon the infotainment display 115 or to change radio stations using voice commands.

The infotainment display 115 may also change in some cases without input from an occupant of the automobile. For example, an image of a ringing phone may be automatically displayed on the infotainment display 115 when a telephone call is received in a telephone system that is built into the automobile.

In some other embodiments, the infotainment display 115 may have a passive screen that does not include a touch screen surface. In this case, the images displayed on the infotainment display 115 may be modified using other controls such as a station tuning knob of a radio. The radio station identifiers are displayed on the passive screen of the infotainment display 115 in accordance with the selection made via the tuning knob.

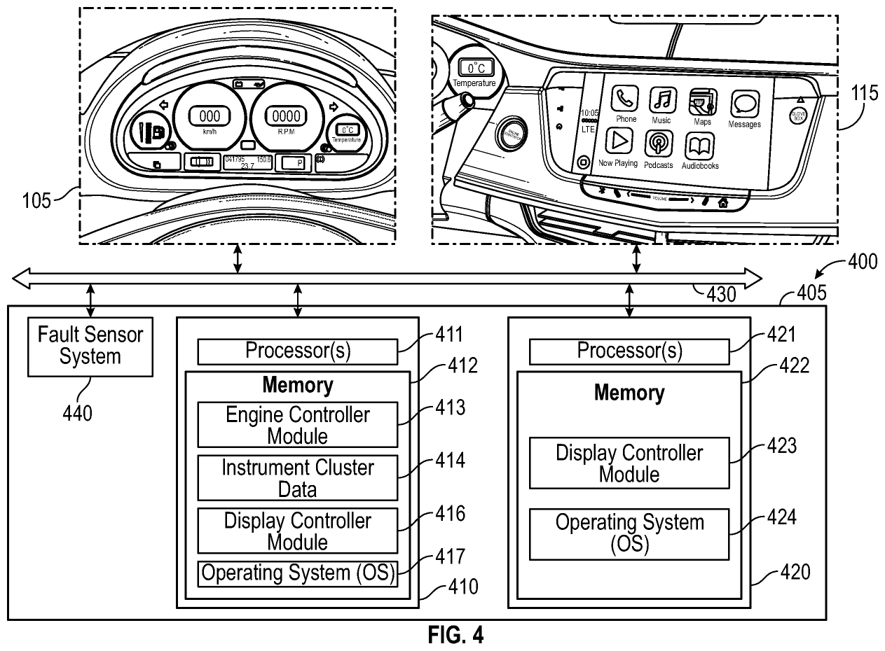

FIG. 4 shows a system 400 for configuring the infotainment display 115 to operate as a backup display to the electronic instrument cluster 105 in accordance with an exemplary embodiment of the disclosure. The system 400 can include the electronic instrument cluster 105, the infotainment display 115, and a controller system 405. These three components as well as other components (not shown) are communicatively coupled to each other through a bus 430. The bus 430 can be any of various types of vehicle buses that provide communications interconnectivity between various components in a vehicle, such as a Controller Area Network (CAN) bus and/or a Local Interconnect Network (LIN) bus. In some embodiments, the bus 430 can be implemented using a single format such as a CAN bus format. However, in some other embodiments, the bus 430 can be implemented using multiple buses and/or multiple bus formats. For example, a portion of the bus 430 can include a CAN bus that is used to support critical applications associated with operating an engine of the automobile, and another portion of the bus 430 can be a LIN bus for supporting non-critical applications in the automobile. The LIN bus may support remote operations in some implementations.

The controller system 405 can include various components such as a first computer 410 and a second computer 420 and can further include various other components (not shown) such as input/output interfaces, sensors, and electromechanical devices (switches, relays, circuit breakers, etc.). The first computer 410 may include several components such as a processor 411 and a memory 412. The memory 412, which is one example of a non-transitory computer-readable medium, may be used to store an operating system (OS) 417 and various other code modules such as an engine controller module 413 and a display controller module 416. The memory 412 may also be used to store data and information such as instrument cluster data 414.

The various code modules can be configured to carry out various operations in cooperation with various types of hardware provided in the automobile. For example, the engine controller module 413 can include one or programs that are executed by the processor 411 in cooperation with various hardware components of the automobile. Some exemplary hardware components include the accelerator, the braking system, the lubrication system, the air-conditioning system, and various components of the engine associated with engine operations. As another example, the display controller module 416 can include one or programs that are executed by the processor 411 for displaying the various graphical representations and other visual content in the electronic instrument cluster 105 and the infotainment display 115.

The instrument cluster data 414 may include data that is generated when the engine controller module 413 is cooperating with the various hardware and software components in the automobile. For example, the instrument cluster data 414 may include real-time data used by the first computer 410 to generate the various graphical representations in the electronic instrument cluster 105. As one example, the instrument cluster data 414 can include real-time speed data that is used to generate the speedometer 106 and real-time engine rpm data used to generate the tachometer 107 on the electronic instrument cluster 105 by the first computer 410. The instrument cluster data 414 may further include data such as mileage data for generating the odometer 220, vehicle maintenance data for generating an engine status icon, and fluid level data for generating a “Check Engine” message on the electronic instrument cluster 105.

The second computer 420 may include several components such as a processor 421 and a memory 422. The memory 422, which is another example of a non-transitory computer-readable medium, may be used to store an operating system (OS) 424 and various other code modules such as a display controller module 423. The second computer 420 may have a handshake arrangement with the first computer 410 and other components in the controller system 405 (such as a fault sensor system 440). The handshake arrangement may be executed by using the bus 430 in one exemplary implementation. In another exemplary implementation, the second computer 420 may wirelessly communicate with the first computer 410 for executing the handshake arrangement. When communicating wirelessly, the bus 430 may be omitted, or may be used in a supplementary or complementary manner. In yet another exemplary implementation, a single computer can be used in place of the first computer 410 and the second computer 420. The single computer can include a processor and a memory that contains some or all of the modules and data that is stored in the memory 412 and the memory 422 of the first computer 410 and the second computer 420 respectively.

The fault sensor system 440 can include various types of sensors for detecting one or more faults in the electronic instrument cluster 105. For example, one or more power supply sensors may be used to detect a fault in a power supply coupled to the electronic instrument cluster 105 and/or to detect a faulty voltage/current condition in the electronic instrument cluster 105. As another example, one or more defect sensors may be used to detect a fault in a first transducer that generates engine rpm information for display on the tachometer 107 and/or to detect a fault in a second transducer that generates automobile speed information for display on the speedometer 106.

The display controller module 423 may be configured to carry out various operations in cooperation with various types of hardware provided in the automobile such as the first computer 410 and the fault sensor system 440. The various operations may include providing signals to the infotainment display 115 for generating the various graphics (controls and icons) displayed on the infotainment display 115.

A memory device such as the memory 412 and the memory 422 can include any one memory element or a combination of volatile memory elements (e.g., random access memory (RAM, such as DRAM, SRAM, SDRAM, etc.)) and non-volatile memory elements (e.g., ROM, hard drive, tape, CD ROM, etc.). Moreover, the memory device may incorporate electronic, magnetic, optical, and/or other types of storage media. In the context of this document, a “non-transitory computer-readable medium” can be, for example, but not limited to, an electronic, magnetic, optical, electromagnetic, infrared, or semiconductor system, apparatus, or device. More specific examples (a non-exhaustive list) of the computer-readable medium would include the following: a portable computer diskette (magnetic), a random-access memory (RAM) (electronic), a read-only memory (ROM) (electronic), an erasable programmable read-only memory (EPROM, EEPROM, or Flash memory) (electronic), and a portable compact disc read-only memory (CD ROM) (optical). Note that the computer-readable medium could even be paper or another suitable medium upon which the program is printed, since the program can be electronically captured, for instance, via optical scanning of the paper or other medium, then compiled, interpreted or otherwise processed in a suitable manner if necessary, and then stored in a computer memory.

In the context of software, the operations described herein with respect to computers such as the first computer 410 and the second computer 420 may be implemented by computer-executable instructions stored on one or more non-transitory computer-readable media such as the memory 412 and the memory 422, that, when executed by one or more processors such as the processor 411 and the processor 421 respectively, perform the recited operations. Generally, computer-executable instructions include routines, programs, objects, components, data structures, and the like that perform particular functions or implement particular abstract data types.

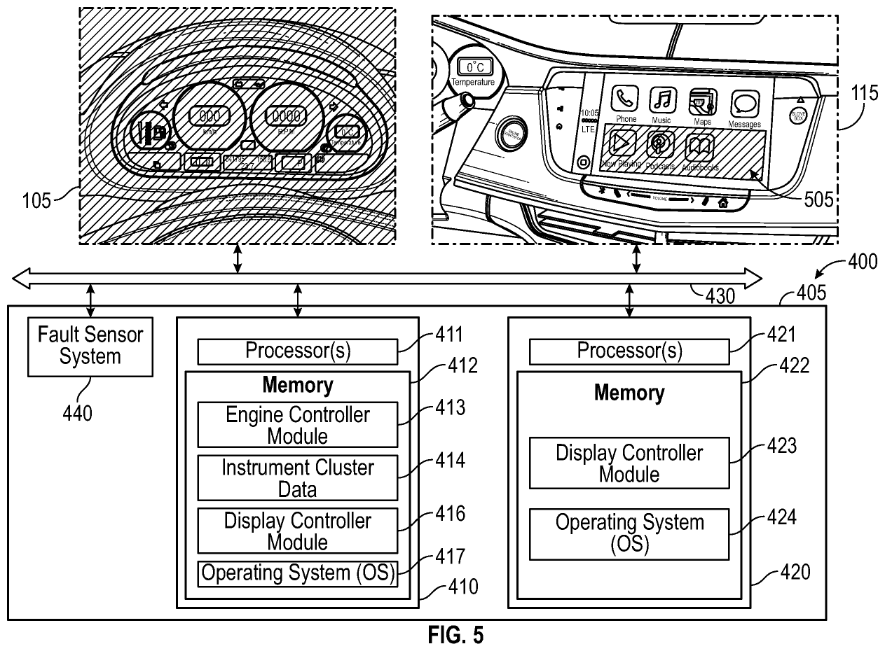

FIG. 5 shows the infotainment display 115 having a first exemplary display configuration when operating as a backup display upon the occurrence of a fault in the electronic instrument cluster 105. The first computer 410 may receive status signals and/or fault indicators from the electronic instrument cluster 105 and other components via the bus 430 and may also transmit various signals to the second computer 420 and other components, via the bus 430. The various signals can include drive signals to the electronic instrument cluster 105 and/or the infotainment display 115. The various types of status signals received by the second computer 420 can include status signals that provide fault information associated with various types of faults in various components such as the electronic instrument cluster 105, a power supply, an electro-mechanical component, and/or a mechanical component.

In an exemplary scenario, the electronic instrument cluster 105 goes blank (as shown in FIG. 5) due to a fault in a power supply or due to a blown fuse. In another exemplary scenario, one or more of the graphical representations (such as the speedometer 106 or the tachometer 107) may disappear, or display erroneous values, due to a different type of fault such as a defect in a display driver board. The fault sensor system 440 detects the occurrence of the fault (or faults) and provides fault information to the first computer 410. In some cases, the fault sensor system 440 may detect the fault (or faults) and provide fault information to the first computer 410 before the fault can adversely impact the electronic instrument cluster 105.

Upon receiving the fault information from the fault sensor system 440, the processor 411 in the first computer 410 may utilize the display controller module 416 and the instrument cluster data 414 to configure the infotainment display 115 to operate as a backup display in accordance with the disclosure. In an exemplary procedure, the instrument cluster data 414, which can include real-time speed data and real-time engine rpm data for example, may be communicated to the second computer 420. In another exemplary procedure, the instrument cluster data 414 may be stored in parallel, in the memory 422 of the second computer 420. The second computer 420 may utilize the instrument cluster data 414 (or the instrument cluster data stored in the memory 422) to modify the infotainment display 115. The modification may be carried out by the processor 421 that executes computer-executable instructions stored in the display controller module 423.

In this exemplary embodiment, the modification of the infotainment display 115 is carried out by displaying, on the infotainment display 115, a graphical representation 505 that is a replica of the electronic instrument cluster 105 just prior to the occurrence of a fault. In one implementation, the graphical representation 505 is displayed as a pop-up window that is overlaid upon a portion of the display screen of the infotainment display 115. The second computer 420 and/or the first computer 410 updates the graphical representation 505 in real-time to display the various operating parameters of the automobile such as speed, rpm, and engine conditions. The touch screen of the infotainment display 115 remains in use for activating the various icons present on the infotainment display 115 outside the pop-up window, but is not functional for use upon the pop-up window portion that replicates the electronic instrument cluster 105.

In another implementation, the pop-up window portion is operative as a human-machine interface (HMI) or a graphical user interface (GUI), and the touch screen may be used by an occupant of the vehicle to operate the GUI for modifying the graphics and icons displayed in the graphical representation 505. The graphical representation 505 can include an icon or a warning message such as “Repair faulty display!” or “Fault in instrument cluster. Servicing required” to alert the driver of the fault in the electronic instrument cluster 105.

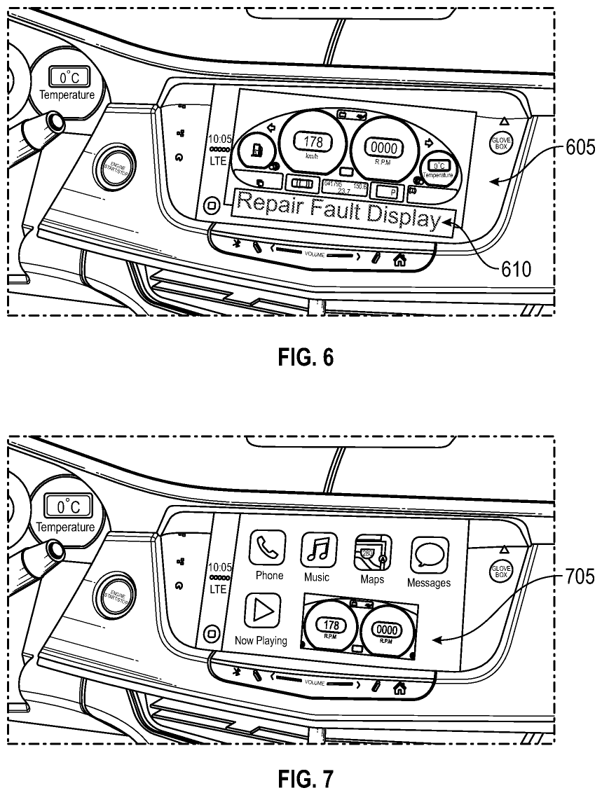

FIG. 6 shows the infotainment display 115 having a second exemplary display configuration when operating as a backup display upon the occurrence of a fault in the electronic instrument cluster 105. In this configuration, a graphical representation 605 that is a replica of the electronic instrument cluster 105 just prior to the occurrence of a fault replaces the various icons and images that were present in the infotainment display 115 prior to the fault. The second computer 420 and/or the first computer 410 updates the graphical representation 605 in real-time to display the various operating parameters of the automobile such as speed, rpm, and engine conditions. Some or all of the graphics displayed in the graphical representation 605 pertain to critical operations associated with the automobile. Consequently, the graphical representation 605 is configured to prevent an occupant of the automobile from modifying or closing the graphical representation 605. The graphical representation 605 can include an icon or a warning message 610 such as “Repair faulty display!” or “Fault in instrument cluster. Servicing required” to alert the driver of the fault in the electronic instrument cluster 105.

FIG. 7 shows the infotainment display 115 having a third exemplary display configuration when operating as a backup display upon the occurrence of a fault in the electronic instrument cluster 105. In this configuration, a graphical representation 705 includes some, but not all, of the graphics displayed on the electronic instrument cluster 105 just prior to the occurrence of a fault. For example, the graphical representation 705 may include the speedometer 106 and the tachometer 107 but omit other graphics such as the odometer 220 and the gear position indicator 225. The graphical representation 705 may be provided as a GUI or as a non-modifiable graphical representation and can also include an icon or a warning message such as “Repair faulty display!” or “Fault in instrument cluster. Servicing required” to alert the driver of the fault in the electronic instrument cluster 105.

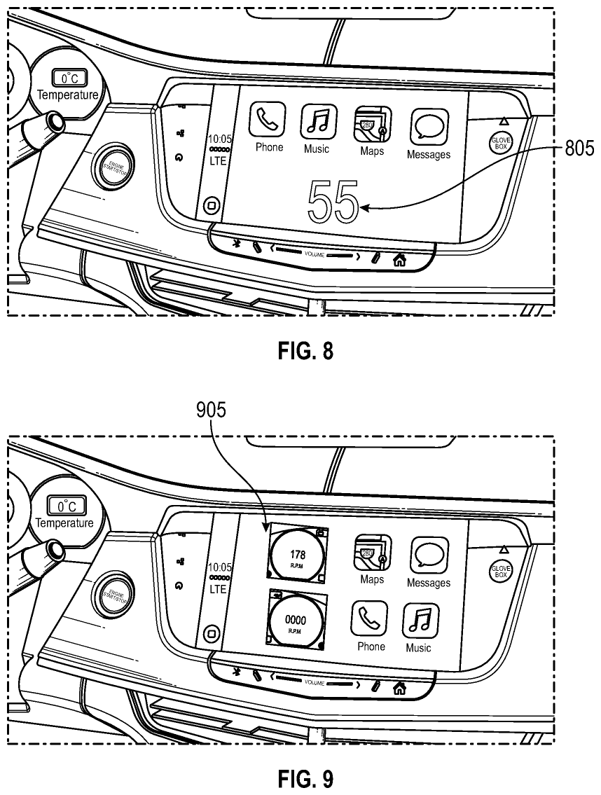

FIG. 8 shows the infotainment display 115 having a fourth exemplary display configuration when operating as a backup display upon the occurrence of a fault in the electronic instrument cluster 105. In this configuration, a graphical representation 805 is a variant of at least one graphic that was displayed on the electronic instrument cluster 105 just prior to the occurrence of a fault. In this example, the graphical representation 805 includes a numerical representation of the speedometer 106 that was displayed on the electronic instrument cluster 105 prior to the occurrence of the fault. The numerical representation is updated in real-time by the first computer 410 and/or the second computer 420 to indicate a speed of the automobile.

FIG. 9 shows the infotainment display 115 having a fifth exemplary display configuration when operating as a backup display upon the occurrence of a fault in the electronic instrument cluster 105. In this configuration, the graphical representation 905 shows that two or more graphics such as the speedometer 106 and the tachometer 107 are displayed on the infotainment display 115 in a vertical orientation arrangement unlike the side-by-side arrangement of these graphics in the electronic instrument cluster 105 prior to the occurrence of a fault. The various graphics may be arranged in various other positions in other implementations. For example, the speedometer 106 may be displayed in a numerical format (as shown in FIG. 8) on a lower portion of the infotainment display 115, and the tachometer 107 may be displayed in the form of an analog gauge on a different area of the infotainment display 115.

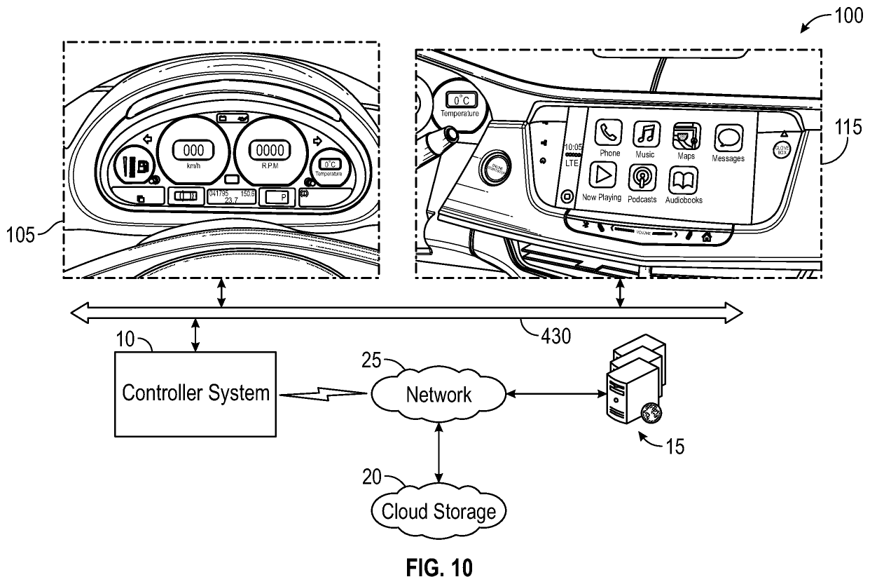

FIG. 10 shows an exemplary system 100 that can be used to configure the infotainment display 115 to operate as a backup display to the electronic instrument cluster 105 in accordance with an exemplary embodiment of the disclosure. The exemplary system 100 includes a controller system 10 that is communicatively coupled to the electronic instrument cluster 105 and the infotainment display 115 via the bus 430. The controller system 10 may include some or all parts of the controller system 405 described above, and can execute various functions carried out by the controller system 405. In the exemplary system 100, the controller system 10 further includes a wireless communication system that permits the controller system 10 to communicate through a network 25 with various elements such a server computer system 15 and cloud storage 20.

The server computer system 15, which can include one or more computers, may be configured to complement or supplement some of the operations performed by the controller system 10. In one exemplary implementation, the server computer system 15 may perform some or all of the functions performed by the first computer 410 and/or the second computer 420 that can be included in the controller system 10. In another exemplary implementation, the server computer system 15 performs all of the functions of the second computer 420, thereby allowing for omission of the second computer 420 in the controller system 10.

The cloud storage 20 can be used to store certain kinds of data that may be different than the data stored in the instrument cluster data 414. For example, the cloud storage 20 can contain mileage data, odometer data, and vehicle information from public records or other sources. The server computer system 15 may access the cloud storage 20 for fetching this data and providing the data to the controller system 10.

The automobile referred to herein can be a driver-operated vehicle or an autonomous vehicle. The server computer system 15 may assist the controller system 10 to execute some functions associated with autonomous operations when the automobile containing the electronic instrument cluster 105 and the infotainment display 115 is an autonomous vehicle. An autonomous vehicle may be alternatively referred to as a robotic vehicle or a self-driving vehicle. The occupants of the autonomous vehicle may desire to operate the infotainment display 115 at various times such as when the electronic instrument cluster 105 is working normally or for operating a GUI displayed upon the infotainment display 115 when the electronic instrument cluster 105 develops a fault.

### Example Embodiments

In some instances, the following examples may be implemented together or separately by the systems and methods described herein.

Example 1 may include a method comprising: detecting, by at least a first computer, an occurrence of at least a first fault in an electronic instrument cluster of an automobile, wherein the electronic instrument cluster comprises one or more graphics displayed thereon; and displaying on an infotainment display of the automobile, upon detecting the occurrence of the at least the first fault, the one or more graphics displayed on the electronic instrument cluster prior to the occurrence of the at least the first fault in the electronic instrument cluster.

Example 2 may include the method of example 1, wherein the one or more graphics displayed on the electronic instrument cluster comprise at least one of a speedometer, a tachometer, an odometer, a temperature gauge, an engine status icon, or an airbag status icon.

Example 3 may include the method of example 2 and/or some other example herein, wherein the one or more graphics are dynamically updated in a real-time mode of operation, and further wherein the one or more graphics are displayed in one of a pop-up window or a panel on the infotainment display.

Example 4 may include the method of example 1 and/or some other example herein, further comprising: displaying, on the infotainment display, an interactive human machine interface that provides human interactivity with the one or more graphics displayed on the infotainment display.

Example 5 may include the method of example 1 and/or some other example herein, wherein the one or more graphics displayed on the electronic instrument cluster prior to the occurrence of the at least the first fault in the electronic instrument cluster replace one or more graphics displayed on the infotainment display prior to the occurrence of the at least the first fault in the electronic instrument cluster.

Example 6 may include the method of example 1 and/or some other example herein, further comprising: displaying, on the infotainment display, at least one of an icon that indicates the occurrence of the first fault in the electronic instrument cluster, or a message that addresses the first fault in the electronic instrument cluster.

Example 7 may include the method of example 1 and/or some other example herein, wherein the first computer is one of located in the automobile or is a cloud computer that is communicatively coupled to the automobile through a wireless communication network.

Example 8 may include a system comprising: an automobile comprising: an electronic instrument cluster; and an infotainment display configured to operate as a replacement for the electronic instrument cluster upon occurrence of at least a first fault in the electronic instrument cluster; and a controller system comprising: at least one memory that stores computer-executable instructions; and at least one processor configured to access the at least one memory and execute the computer-executable instructions to at least: detect the occurrence of at least the first fault in the electronic instrument cluster; and display on the infotainment display, upon detection of the first fault in the electronic instrument cluster, at least one of one or more graphics displayed on the electronic instrument cluster or graphical variants of the one or more graphics displayed on the electronic instrument cluster.

Example 9 may include the system of example 8, wherein the one or more graphics displayed on the electronic instrument cluster comprise at least one of a speedometer, a tachometer, an odometer, a temperature gauge, an engine status icon, or an airbag status icon.

Example 10 may include the system of example 9 and/or some other example herein, wherein the one or more graphics are dynamically updated by the at least one processor in a real-time mode of operation.

Example 11 may include the system of example 8 and/or some other example herein, wherein the computer is a part of a controller system that is coupled to the electronic instrument cluster and the infotainment display, the controller system configured to at least receive one or more status signals from the electronic instrument cluster and transmit to the infotainment display, one or more drive signals for displaying the one or more graphics on the infotainment display.

Example 12 may include the system of example 11 and/or some other example herein, wherein the one or more status signals provide an indication of at least the first fault in the electronic instrument cluster.

Example 13 may include the system of example 11 and/or some other example herein, wherein the first fault is at least one of a power supply fault, a display screen fault, a component fault, or a mechanical fault in the electronic instrument cluster.

Example 14 may include the system of example 8 and/or some other example herein, wherein the one or more graphics are displayed in one of a pop-up window or a panel on the infotainment display.

Example 15 may include a method comprising: coupling a controller system to an electronic instrument cluster and an infotainment display in an automobile; receiving, in the controller system, at least a first status signal that indicates an occurrence of a fault in the electronic instrument cluster; and transmitting, to the infotainment display, one or more drive signals for displaying on the infotainment display, at least one graphic that was displayed on the electronic instrument cluster prior to the occurrence of the fault.

Example 16 may include the method of example 15, wherein the at least one graphic displayed on the electronic instrument cluster prior to the occurrence of the fault is one of a speedometer, a tachometer, an odometer, a temperature gauge, an engine status icon, or an airbag status icon.

Example 17 may include the method of example 16 and/or some other example herein, wherein the at least one graphic is dynamically updated by the controller system to indicate a current operating state of the automobile.

Example 18 may include the method of example 15 and/or some other example herein, wherein the fault is one of a power supply fault, a display screen fault, a component fault, or a mechanical fault in the electronic instrument cluster.

Example 19 may include the method of example 15 and/or some other example herein, wherein the at least one graphic is displayed in one of a pop-up window or a panel on the infotainment display.

Example 20 may include the method of example 15 and/or some other example herein, further comprising: displaying, on the infotainment display, at least one of an icon that indicates the occurrence of the fault in the electronic instrument cluster, or a message that addresses the fault in the electronic instrument cluster.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, one skilled in the art will recognize such feature, structure, or characteristic in connection with other embodiments whether or not explicitly described.

Implementations of the systems, apparatuses, devices, and methods disclosed herein may comprise or utilize one or more devices that include hardware, such as, for example, one or more processors and system memory, as discussed herein.

An implementation of the devices, systems, and methods disclosed herein may communicate over a computer network. A “network” and a “bus” is defined as one or more data links that enable the transport of electronic data between computer systems and/or modules and/or other electronic devices. When information is transferred or provided over a network, a bus, or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of non-transitory computer-readable media.

Computer-executable instructions comprise, for example, instructions and data which, when executed at a processor, cause the processor to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the present disclosure may be practiced in network computing environments with many types of computer system configurations, including in-dash vehicle computers, personal computers, desktop computers, laptop computers, message processors, handheld devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors and may include hardware logic/electrical circuitry controlled by the computer code. These example devices are provided herein for purposes of illustration and are not intended to be limiting. Embodiments of the present disclosure may be implemented in further types of devices, as would be known to persons skilled in the relevant art(s).

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method comprising:
detecting, by at least a first computer, an occurrence of at least a first fault in an electronic instrument cluster of an automobile, wherein the electronic instrument cluster comprises one or more graphics displayed thereon; and
displaying on an infotainment display of the automobile, upon detecting the occurrence of the at least the first fault, the one or more graphics displayed on the electronic instrument cluster prior to the occurrence of the at least the first fault in the electronic instrument cluster.

2. The method of claim 1, wherein the one or more graphics displayed on the electronic instrument cluster comprise at least one of a speedometer, a tachometer, an odometer, a temperature gauge, an engine status icon, or an airbag status icon.

3. The method of claim 2, wherein the one or more graphics are dynamically updated in a real-time mode of operation, and further wherein the one or more graphics are displayed in one of a pop-up window or a panel on the infotainment display.

4. The method of claim 1, further comprising:
displaying, on the infotainment display, an interactive human machine interface that provides human interactivity with the one or more graphics displayed on the infotainment display.

5. The method of claim 1, wherein the one or more graphics displayed on the electronic instrument cluster prior to the occurrence of the at least the first fault in the electronic instrument cluster replace one or more graphics displayed on the infotainment display prior to the occurrence of the at least the first fault in the electronic instrument cluster.

6. The method of claim 1, further comprising:
displaying, on the infotainment display, at least one of an icon that indicates the occurrence of the first fault in the electronic instrument cluster, or a message that addresses the first fault in the electronic instrument cluster.

7. The method of claim 1, wherein the first computer is one of located in the automobile or is a cloud computer that is communicatively coupled to the automobile through a wireless communication network.

8. A system comprising:
an automobile comprising:
an electronic instrument cluster; and
an infotainment display configured to operate as a replacement for the electronic instrument cluster upon occurrence of at least a first fault in the electronic instrument cluster; and
a controller system comprising:
at least one memory that stores computer-executable instructions; and
at least one processor configured to access the at least one memory and execute the computer-executable instructions to at least:
detect the occurrence of at least the first fault in the electronic instrument cluster; and
display on the infotainment display, upon detection of the first fault in the electronic instrument cluster, at least one of one or more graphics displayed on the electronic instrument cluster or graphical variants of the one or more graphics displayed on the electronic instrument cluster.

9. The system of claim 8, wherein the one or more graphics displayed on the electronic instrument cluster comprise at least one of a speedometer, a tachometer, an odometer, a temperature gauge, an engine status icon, or an airbag status icon.

10. The system of claim 9, wherein the one or more graphics are dynamically updated by the at least one processor in a real-time mode of operation.

11. The system of claim 8, wherein the computer is a part of a controller system that is coupled to the electronic instrument cluster and the infotainment display, the controller system configured to at least receive one or more status signals from the electronic instrument cluster and transmit to the infotainment display, one or more drive signals for displaying the one or more graphics on the infotainment display.

12. The system of claim 11, wherein the one or more status signals provide an indication of at least the first fault in the electronic instrument cluster.

13. The system of claim 11, wherein the first fault is at least one of a power supply fault, a display screen fault, a component fault, or a mechanical fault in the electronic instrument cluster.

14. The system of claim 8, wherein the one or more graphics are displayed in one of a pop-up window or a panel on the infotainment display.

15. A method comprising:
coupling a controller system to an electronic instrument cluster and an infotainment display in an automobile;
receiving, in the controller system, at least a first status signal that indicates an occurrence of a fault in the electronic instrument cluster; and
transmitting, to the infotainment display, one or more drive signals for displaying on the infotainment display, at least one graphic that was displayed on the electronic instrument cluster prior to the occurrence of the fault.

16. The method of claim 15, wherein the at least one graphic displayed on the electronic instrument cluster prior to the occurrence of the fault is one of a speedometer, a tachometer, an odometer, a temperature gauge, an engine status icon, or an airbag status icon.

17. The method of claim 16, wherein the at least one graphic is dynamically updated by the controller system to indicate a current operating state of the automobile.

18. The method of claim 15, wherein the fault is one of a power supply fault, a display screen fault, a component fault, or a mechanical fault in the electronic instrument cluster.

19. The method of claim 15, wherein the at least one graphic is displayed in one of a pop-up window or a panel on the infotainment display.

20. The method of claim 15, further comprising:
displaying, on the infotainment display, at least one of an icon that indicates the occurrence of the fault in the electronic instrument cluster, or a message that addresses the fault in the electronic instrument cluster.
